(19) United States
(12) Patent Application Publication
(10) Pub. No.: US 2003/0163936 A1
(43) Pub. Date: Sep. 4, 2003

(54) Calendar with a plurality of receiving chambers

(76) Inventors: Jurgen Floss, Wernsdorf (DE); Christian Olbrich, Glauchau (DE)

Correspondence Address: HORST KASPER, 13 FOREST DRIVE, WARREN, NJ, 07059, US

(21) Appl. No.: 10/218,200

(22) Filed: Aug. 13, 2002

(30) Foreign Application Priority Data
Mar. 1, 2002 (DE) 202 03 242.6

(51) Int. Cl. G09D 3/00; G09D 3/02

(52) U.S. Cl. 40/107; 40/122

(57) ABSTRACT

A calendar is furnished with a plurality of receiving chambers for containing removable objects. The receiving chambers are openable for the purpose of removing of the objects. The objects (9) placed in the receiving chambers (4) are intended for the use by pets and are suitable for pets and comprise in particular feeding agents and/or the objects are useful as a toy.

### BACKGROUND OF THE INVENTION

1. Field of the Invention

The invention relates to a calendar with a plurality of receiving chambers for the reception of removable objects, wherein the receiving chambers can be opened for removal of the objects.

2. Brief Description of the Background of the Invention Including Prior Art

Such calendars are known in particular as advent calendars in different constructions. It is prevailingly known therewith to furnish candy and presents as removable objects. Furthermore there is described a reception of certain formed parts in the German printed patent document DE 20014306 U1, which form parts can for example find use as decoration, jewelry or formed parts, while the German printed patent document DE 29704311 U1 teaches an advent calendar for cases of beer.

It is common to these known calendars that they are employed as an advent calendar around Christmas time and that they are consequently directed to the human being. A receiving chamber is coordinated to each day of the pre-Christmas time in the month of December, wherein the receiving chamber contains removable objects which are to prepare surprise and happiness to the human being and in particular to children in view of the approaching Christmas celebration.

Pets, such as for example dogs, cats, rabbits and other rodents, birds . . . have a continuously increasing positional value in the civilized world, since the pets generate happiness, serve for a removal of stress, increase the understanding of nature and oppose the loneliness of certain persons, in particular of sick persons and seniors. In this respect the maintaining of the pets in the narrower living region exerts among other things an express positive influence on the well-being and the health of the human being. However, the friend of the pet has up to now no possibility to prepare surprise and/or happiness to the pet at particular occasions under employment of a calendar of the initially recited kind. In particular these objects removable from the receiving chambers are not suitable for the pet or domestic animal, that is in general, the objects are even damaging for the pet.

### SUMMARY OF THE INVENTION

1. Purposes of the Invention

In view of the disadvantages of this known state-of-the-art, it is an object of the present invention to provide a calendar of the recited kind, which calendar allows the owners of pets to prepare a surprise or, respectively, happiness and/or a reward for the pet at special occasions and to express in this manner the particular connection to the pet.

These and other objects and advantages of the present invention will become evident from the description which follows.

2. Brief Description of the Invention

In accordance with the present invention this object is achieved by furnishing the objects received in the receiving chambers for the use of pets and by being suitable for pets and comprising particular feeding agents and/or by being employable as toys.

The calendar for domestic animals has a plurality of receiving means for removable objects. The receiving means are openable for the purpose of removing of the objects. The objects placed in the receiving means are intended for the use by pets and are suitable for pets and comprise in particular feeding agents and/or are useful as a toy. The receiver means can be opened for the purpose of removal of the objects. The objects are furnished and adapted for use by domestic animals. The objects include animal feed agents or toys for animals. The objects are furnished as form bodies, which form bodies comprise exclusively or predominantly feed agent materials for domestic animals. The objects can be furnished as molded bodies which comprise domestic animal fodder means.

Preferably the calendar for domestic animals comprises a calendar front, a plurality of receiver means disposed behind the calendar front, a plurality of pet consumption articles disposed in the plurality of receiver means, and a plurality of shutters disposed in the calendar front, disposed in front of the pet consumption articles and corresponding to the plurality of receiver means, wherein the shutters are closable for harboring the pet consumption articles and are openable for releasing the pet consumption articles.

A plurality of shaped envelope jackets can be furnished for surrounding the plurality of pet consumption articles, wherein the pet consumption articles comprise particle like fodder means, which have received a shape based on the shaped envelope jackets surrounding particle like fodder means. A support can be furnished for holding the receiver means, wherein the support is attached to the calendar front. The shutters are furnished as doors, wherein the doors are flippable out of the calendar front by employing of a member of the group consisting of folding lines, perforation elements, intended pre-weakened breakage positions, and combinations thereof for performing a hinge function of said doors.

The form bodies are produced out of particle like or out of massive or out of particle like and massive feeding agent materials. The objects are a member of the group consisting of particle derived fodder means, massive fodder means, particle derived and massive fodder means and of mixtures thereof. The form bodies are produced with filling or without filling. The objects include molded bodies with a filling.

The feeding agent materials have admixed ballast materials, active agents, trace elements, minerals, and/or binding agents and the like. The objects comprise exclusively or predominantly particle like feed agent materials, which have received a shape by enveloping. The objects comprise particle like fodder means, which have received a shape based on a shaped envelope surrounding the particle like fodder means. The objects can be packed or are not packed. Preferably, the objects are packaged. The objects can exhibit an outer form inciting the respective drive to play and in particular a regular or irregular outer shape such that they have a more or less limited moveability. The objects exhibit a regular or irregular outer shape exciting the respective drive of a domestic animal to play and exhibiting a more or less limited moveability.

The objects can be furnished with one or several attachment agents, in particular for hanging. The receiving means for the objects comprise in each case a chamber, wherein the chamber is openable and closable by employing a closure element.

A calendar front is provided, wherein the calendar front is disposed in front of a support element, and wherein the calendar front is attached to the support element, wherein receiving means are furnished in the support element comprising individual chambers, and wherein the closure elements coordinated to the chambers are furnished as doors, wherein the doors are flippable out of the calendar front by employing of folding lines and intended breakage and perforation positions. The calendar front can be formed two-dimensional with a geometrically uniform shape or with a contour shape or also three-dimensional. The calendar front can be embellished, colored or covered with motives, in particular with animal motives and/or plant motives.

The support element comprises a suitable working material for the reception of objects made of a feeding agent. The support element can be produced out of plastic, cardboard, or wood or out of a suitable recycling material, coated or uncoated. Preferably, the support element is made out of a member of the group consisting of plastic, cardboard, wood, a suitable reciting material, a coated material and combinations thereof. The support element can be formed with a geometrically uniform shape or with a contour shape corresponding to the shape of the calendar front.

Based on the construction and forming of a calendar according to the present invention the owners of pets now have the possibility to prepare a surprise and happiness to their pets in particular at special occasions or to deliver a reward, which is adapted to the pet and which meets in particular the desires of the pet.

The present invention provides that it is in particular now possible for an owner of a pet and for a friend of a pet to express a special connection to the pet caused by different occasions such as festivals, vacation or vacation care, nursing of the sick and the like, by delivering objects being taken from the calendar for feeding and/or playing. The satisfaction of the eating drive and/or the game drive of the pet, generally together with pleasant bodily contacts, influence the welfare of the pet positively and in turn effect correspondingly positively well feeling back onto the friend of the pet.

The objects are provided as form bodies according to a preferred embodiment of the invention, which form bodies are exclusively or predominantly consisting of feed agent materials. Here the form bodies are produced advantageously out of particle like or out of massive or out of particle like and massive feed agent materials, preferably produced by pressing.

It is furthermore advantageous to admix load materials, ballast materials, effective agents, trace elements, minerals, and/or binding agents or the like. The most different positive effects can thereby be predetermined and achieved. The corresponding holds also for the forming, that the form bodies are produced with or without filling. Here the filling can contain amongst others the above recited materials, which can render easier the acceptance of the materials by the pet.

According to a further advantageous embodiment the objects comprise exclusively or predominantly particle like agent materials, which have received a shape by enveloping. In particular the objects can be packed or without packing.

Advantageously the objects exhibit an outer form exciting the respective drive to play and in particular a regular or irregular outer shape such that the objects have a more or less limited moveability. Depending on a form giving and dimensioning adapted to the concrete pet thus removable objects incite the more or less present drive to play of the pets or, respectively, instigate to eat by playing.

It can be furthermore advantageous for several, in particular climbing pets that the objects are furnished with one or several attachment agents, in particular for hanging. Here this can be eyelets, lugs, loops or the like.

The receiving chambers for these objects comprise in each case the chamber according to the calendar of the present invention, wherein the chamber is openable and closable by employing of a closing element. In particular advantageously and favorable in cost, the calendar comprises a front of a calendar, wherein the front of the calendar is disposed in front of a support element and is attached to the support element, wherein receiving chambers are furnished in the support element comprising individual chambers, and wherein the closure elements coordinated to the chambers are furnished as awards, which can be flipped out of the calendar front by employing of folding lines and intended breakage positions.

According to a further advantageous embodiment, the calendar front is formed two-dimensional with geometrically uniform shape or contour shape or three-dimensional. This calendar front is advantageously covered and/or equipped with motives, in particular with animal and/or plant motives. The support element comprises a suitable material for the acceptance of objects made out of feed material. In particular the support element is made out of plastic, card board or wood or out of a suitable recycling material, coated or uncoated and is formed corresponding to the shape of the calendar front with a geometrically uniform shape or with contour shape.

The novel features which are considered as characteristic for the invention are set forth in the appended claims. The invention itself, however, both as to its construction and its method of operation, together with additional objects and advantages thereof, will be best understood from the following description of specific embodiments when read in connection with the accompanying drawing.

### BRIEF DESCRIPTION OF THE DRAWING

In the accompanying drawing, in which are shown several of the various possible embodiments of the present invention:

FIG. 1 a perspective view of the calendar according to the present invention,

FIG. 2 is a view of a section along section line II-II in FIG. 1,

FIG. 3 is a schematic diagram illustrating operation of the calendar front,

FIG. 4 is a front elevational view of a support element,

FIG. 5 is a sectional view of the support element according to FIG. 4,

FIG. 6 is a front elevational view onto a calendar showing a head of a dog,

FIG. 7 is a front elevational view onto a calendar showing a parrot bird,

FIG. 8 is a front elevational view onto a calendar showing a head of a dog,

FIG. 9 is a schematic diagram showing a reward in the shape of a bone with particle derived fodder,

FIG. 10 is a perspective and in part sectional view of a molded body with a filling,

FIG. 11 is a schematic diagram of a packaged object,

FIG. 12 is a perspective view of a calendar of three dimensional structure.

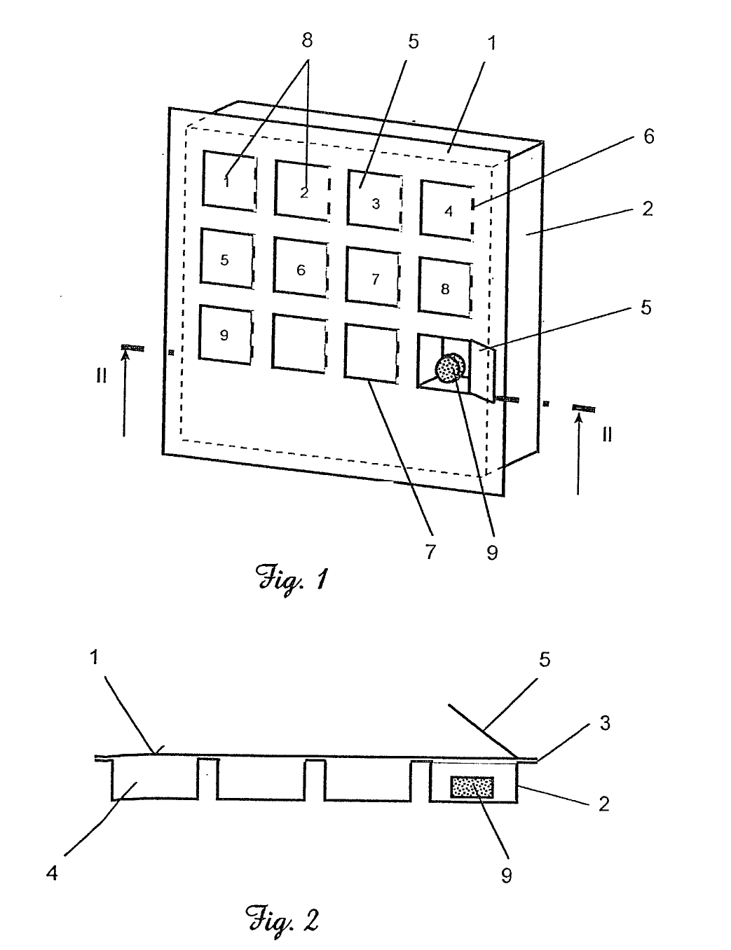

### DESCRIPTION OF INVENTION AND PREFERRED EMBODIMENT

The invention is explained in more detail in the following by way of an embodiment, wherein the calendar comprises a calendar front 1 as well as a support element 2, wherein the calendar front 1 and the support element 2 are glued to each other under employment of adhesive faces 3.

According to the embodiment, the calendar front 1 and the support element 2 have the geometrically uniform base shape of the rectangle, wherein the calendar front 1 represents a planar face. However, the employment of the most different form constructions in a two-dimensional or three-dimensional way, depending on the concrete application case, is possible. The analogously holds for the furnishing of the color and the visual display with motives.

The calendar can have a two-dimensional or three-dimensional shape of all known domestic animals such as locks, cats, rabbits, hares, squirrels, hamsters, mice, rats, fishes, birds, horses, and the like. The calendar can have other geometric forms such as ball shape, cylinder shape, dice shape, square shape, rectangle shape, triangular shape, cuboid or pyramid shape. A calendar having a rectangular cuboid shape is shown in FIG. 12.

The support element 2 comprises a plurality of box shaped recesses 4, which represent the receiving chambers or receiver means. Coordinated to these recesses 4, individual doors 5 are furnished in the front of the calendar 1, such that in each case closed chambers are generated. The doors 5 are formed by the furnishing of bending lines 6 shown in dashed lines for the hinge of each door 5 and by intended breakage positions 7, wherein the intended breakage positions 7 are broken up for the purpose of opening the doors 5, such that the door 5 can be swiveled around the bending line 6. The door 5 is as required again closable by pressing the door 5 in the closed position. Each door 5 carries a numbering 8 coordinated to a certain day.

The closure elements can be doors (5), which can be opened and closed. The inner sides of the doors can be employed for explanations or, respectively, advertising by the producer. The number of the doors depends on the purchase of the use of the calendar for example 24 doors would be employed for a Christmas calendar.

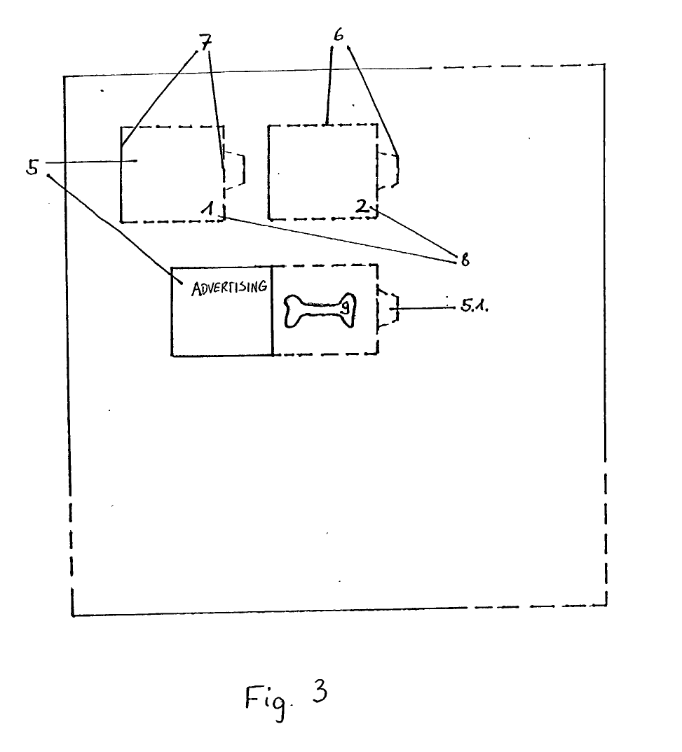

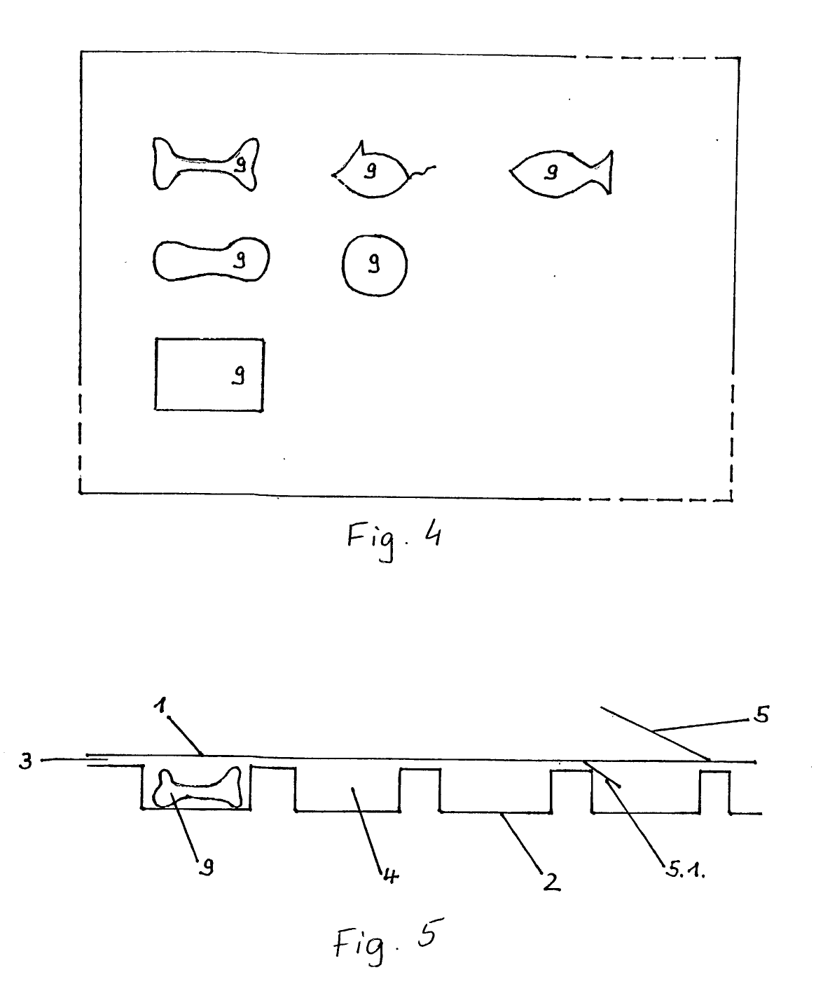

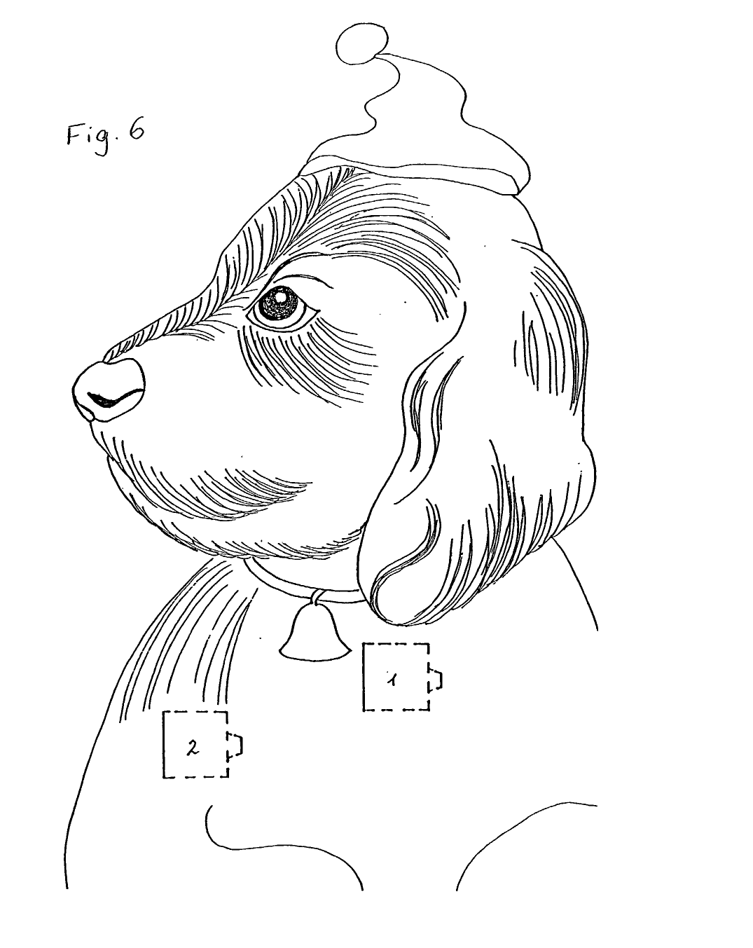

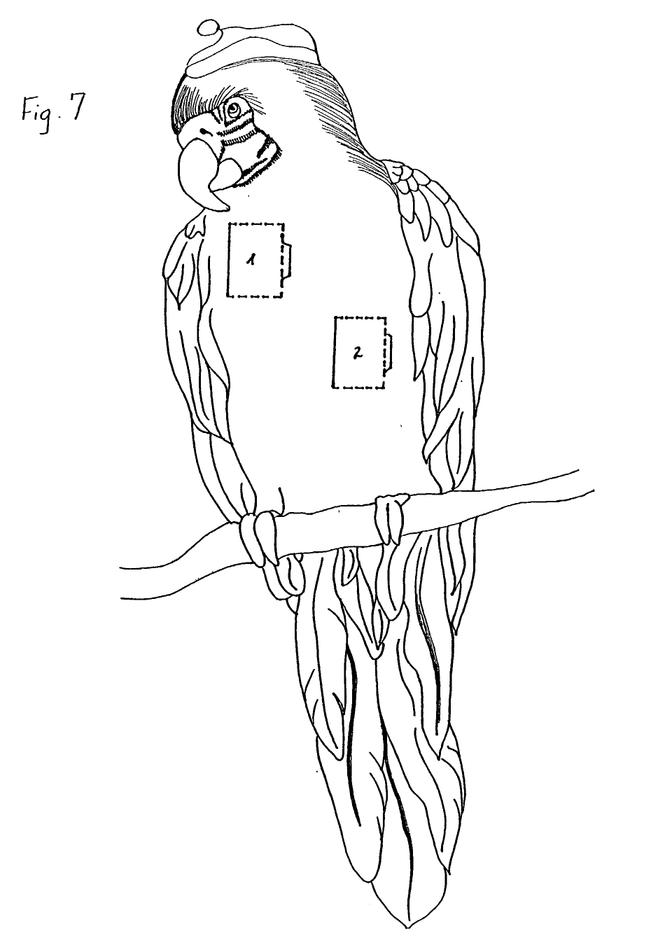

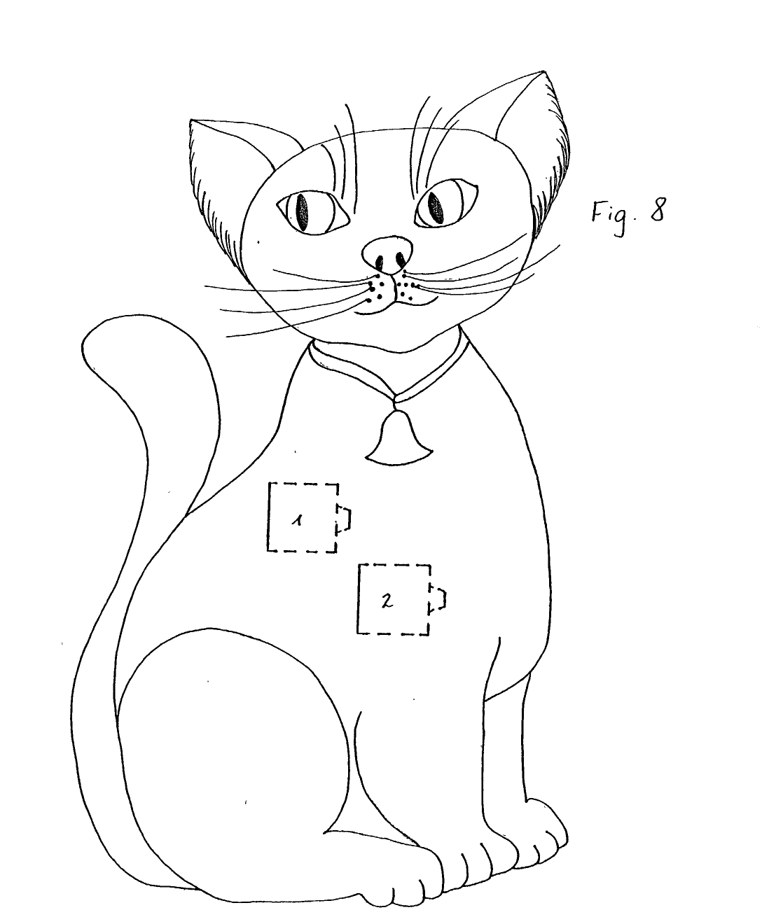

Auxiliary means for opening doors can be folding lines, which can be pressed for rupturing. FIG. 3 shows such a door opening help 5.1 for the doors 5. Here the doors and the door opening help 5.1 are formed at the calendar front. The opening help is formed at the doorframe on the side of the door opposite to the hinge line. The door opening help 5.1 comprises a hinge line disposed relative remote to the hinge line of the door 5 and joins the perforation line of the door. The opening help includes an upper perforation line meeting an upper end of the hinge line of the opening help 5.1 and a lower perforation line meeting a lower end of the hinge line of the opening help. The upper perforation line and the lower perforation line run together in the direction toward the hinge line of the opening help.

The inner faces of the doors can be employed for explanations, for instructions, or for advertising material. The number of doors depends on the purpose of the calendar, for example a Christmas calendar would have 24 doors.

Objects 9 are disposed in the box shaped recesses 4 of the support element 2. The objects 9 are pet-related or objects for consumption by domestic animals and in particular are pet supply articles and pet consumption articles. The size of the objects is preferably from about 0.3 centimeters diameter to 4 centimeters diameter and more preferably from 1 centimeter in diameter to 3 centimeters in diameter. These objects 9 are furnished for and suitable for the use by domestic animals. The objects 9 can be fodder means and or toys for domestic animals. In particular the objects comprise feeding agents and/or are employable as toys.

The compartments comprise animal food materials, animal food agents, food for animals, food for pets, fruit for birds, green animal food, green fodder, food oats. All these food items are prepared for pets or domestic animals. The animal food materials can comprise green fodder such as grass, green corn, clover, trefoil, hay, straw and bran, roots, nodules, bulbs, tubers, potatoes, beets, grains and seeds, horse beans (vicia faba), peas, commercial residues, sugar beet pulp, molasses, potato malt residues, vinasses, swill, slops, oil cakes, animal derived materials, milk derivatives and fodder made thereof, meat meal, fish meal, bone meal, raw fodder made out of dried plants, straw, chaff, paleaceous materials, field peas, fodder cereals.

As suitable and if desired these fodder agents are processed in a suitable way for example by comminuting, mixing, grinding, baking, frying, subjecting to water vapor, boiling, pressing and alike and are in particular brought into the necessary form in the sense of an object.

It is a characterizing feature that these fruit and fodder materials and the correspondingly generated objects are made out of food materials suitable and intended for domestic animals. The production and processing of the fruit and fodder materials for animals are subject to substantially lesser requirements of cleanliness based on the stronger immune system of the animals as compared to the requirements relating to food for humans.

Preferably the fodder materials include tidbits and delicacies for animals, that is there is to be generated an additional positive effect in the sense of a specialty or of a special comfort and well-being of the animal in addition to the eating and satiating experience.

The animal food corresponds to the internationally accepted quality standards for domestic animal food. These standards are recommended by the national research council USA, Fediaf in Brussels, and AAFCOO standard USA. These organizations develop standards with respect to the composition of the various contents materials of the fodder and means, which are adapted to a healthy nourishment of domestic animals such as dogs, cats and the like. Suitable fodder means and toys for domestic animals are commercially available.

The domestic animal fodder means can be animal feed having the shape of mice, dogs, bones, cat tongues and other geometric shapes such as ball shape, cylinder shape, dice shape, square shape, rectangular shape, triangular shape, pyramid shape. The toys for domestic animals can be made out of plastic such as rubber, latex.

Particle derived means that the composition of the individual components of a fodder agent are based on particles.

The shaped envelope can be for example an outer, or less solid shell around the kernel formed in part or completely out of particle like fodder materials. This shell can be formed for example as a sugar coated pill or as a sugar coated candy, by application of meltable materials, for example sugar possibly combined with a coloring agent and a flavoring agent. The envelope is to determine the shape of the object.

FIG. 10 shows a bone shaped object 9 having an outer solid crust 16 surrounding a filling 18, wherein the filling can be liquid, viscous or solid. Both the crust and the filling can be made edible for animals.

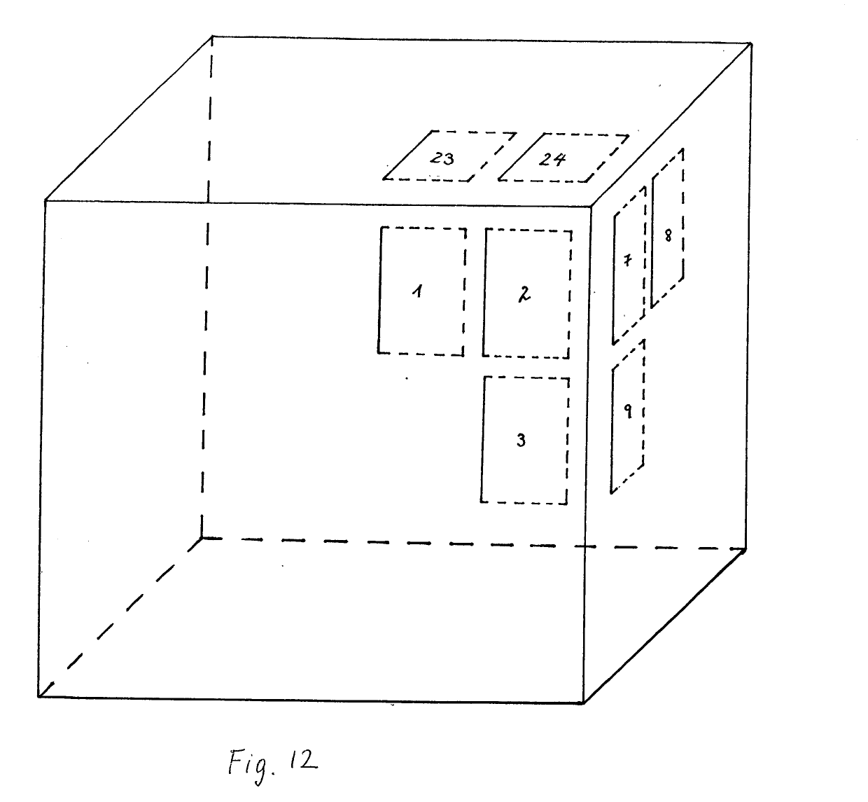

The fodder means can be packaged with the intent of maintaining of the flavor, the quality, the durability, and the suitability and for avoiding the generation of smells. A plastic or metallic or paper based foil 20 can surround the object 9 as shown in FIG. 11. The foil 20 can be crimped together along edge areas 22 for enclosing and sealing the object 9 and for serving as an internal packaging material as shown in FIG. 11.

According to the embodiment the objects 9 are in each case a cylindrical form body, which is formed out of particle like feed agent materials by gentle pressing with employing of a suitable binding agent. As desired vitamins, minerals, ballast materials and the like are admixed to the feed agent materials, wherein the selection of the feeding agent materials and the additive materials depends on the kind of the pet, for which the calendar is intended. At any rate the selection and also the given form of the objects 9 is performed such that if possible a delicacy is delivered to the respective pet and selectively the pet is animated to play or, respectively, to eat by playing.

These objects can be in particular toys for animals. The articles concerned can correspond to and can satisfy the play drive of the domestic animals. Here the selection of form and material of the objects depends concretely on the kind of domestic animal to be considered. In other words a cat likes to play with other objects as compared to a bird.

Animal care products and animal care objects also can form the contents of the compartments of the calendar. Such animal care products which are suitable to generate the well-being of the domestic animals during application and use are preferred, for example a brush for dogs.

A toy for a domestic animal can include a rubber ball, a rubber bone, a rubber mouse, a rubber burger, and alike. In addition fodder means can have the shape of mice, dogs, bones, cats tongues, and other geometric shapes such as balls cylinders, dice, square shapes, rectangular shapes, triangular shapes and pyramid shapes.

It is common both with respect to feed agents as well as with respect to toys, animal care products and alike that these objects do not have to be newly developed. It is intended to employ such articles for animals, which are commercially available in the construction of the calendar. The furnishing and filling of a calendar with the above recited objects for animals is to the center of gravity of the present invention.

An attachment agent in particular for hanging can be for example a cord for hanging the objects (9) with the fodder agent and/or the toys. For example a mirror for a bird could be hanged or small bell could be hanged.

The structuring of the calendar is an important aspect of the present invention, in other words the form of the calendar itself, the colorful and an impression full production of the calendar is to excite both the owner of the domestic animals as well as the domestic animal itself. The calendar can have a three dimensional surface structure such that the shutters of one calendar are facing into two dimensions or into three dimensions as shown in FIG. 12.

The support element 2 as well as the calendar front 1 comprises materials suitable for the reception depending on the feed agent materials of the objects 9 to be received by the calendar. Advantageously for example a psychologically harmless and absolutely safe duroplastic is employed for the support element 2 and a coated cardboard is employed for the calendar front 1.

The invention is not limited by the details of the precedingly described embodiment. In particular the objects 9 can also be furnished as massive or as mixtures of particle like and massive or otherwise formed feeding agent materials in arbitrary suitable form and number for each recess 4.

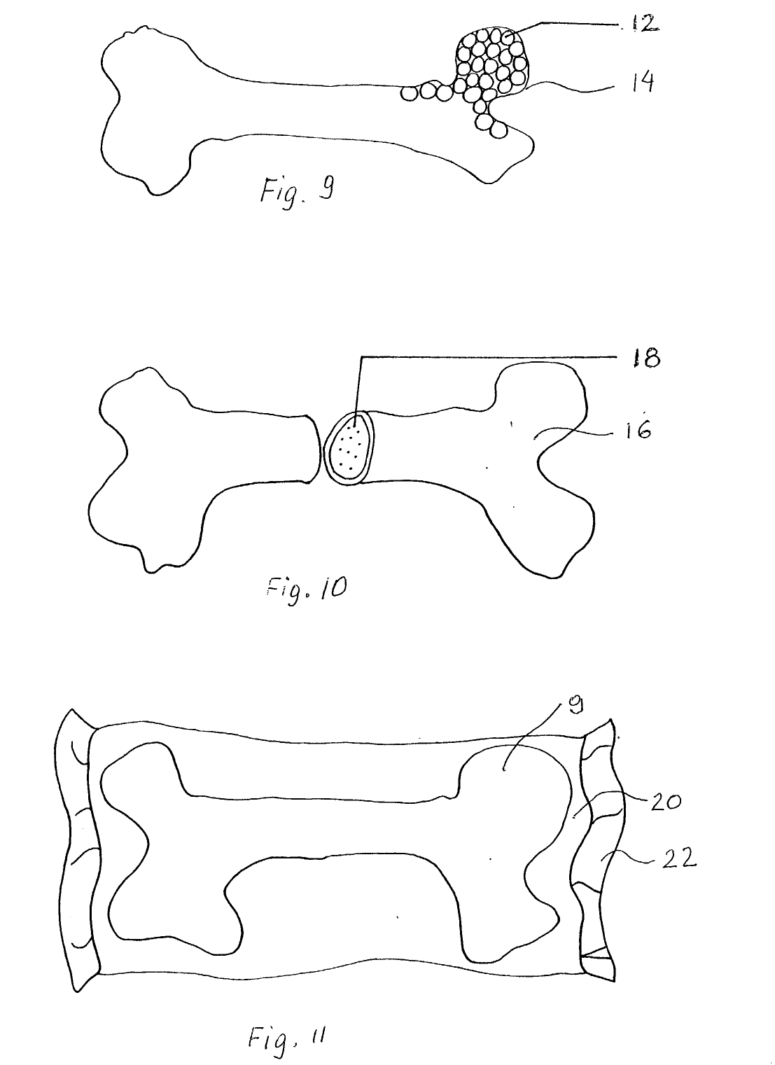

FIG. 9 shows an embodiment of the object 9 is formed of particles 12 surrounded by a formed envelope 14 holding the particles together. The envelope 14 can represent a particular shape like a bone. The particles can have adhering surfaces for stabilizing a form once it is established. Both the envelope 14 and the particles 12 can be made of materials edible for animals.

The calendar can be manually re-filled after acquisition in a filled state and corresponding use and thereby can be multiple times re-employed. Similarly, an offer in an empty state and followed by individual filling by the friend of the animal is possible.

It will be understood that each of the elements described above, or two or more together, may also find a useful application in other types of calendar configurations and remembrance celebrating articles differing from the types described above.

While the invention has been illustrated and described as embodied in the context of a calendar with a plurality of receiving chambers, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

List of Reference Numerals

1 calendar front

2 support element

3 adhesive faces

4 recess, receiving chamber

5 door

6 folding line

7 intended break position

8 numbering

9 object

What is claimed as new and desired to be protected by Letters Patent is set forth in the appended claims:

1. A calendar with a plurality of receiving means for removable objects, wherein the receiving means are openable for the purpose of removing of the removable objects, wherein the objects (9) placed in the receiving means (4) are intended for the use by pets and are suitable for pets and comprise in particular feeding agents and/or are useful as a toy.

2. The calendar according to claim 1 wherein the objects (9) are furnished as form bodies, which form bodies comprise exclusively or predominantly feed agent materials for domestic animals.

3. The calendar according to claim 1 wherein the objects are a member of the group consisting of particle derived fodder means, massive fodder means, particle derived and massive fodder means and of mixtures thereof.

4. The calendar according to claim 1 wherein the objects include fodder agents comprising ballast materials, active agents, trace elements, minerals, and/or binders.

5. The calendar according to claim 1 wherein the objects include molded bodies with a filling or without a filling.

6. The calendar according to claim 1 wherein the objects (9) comprise particle like fodder means, which have received a shape based on a shaped envelope jacket surrounding the particle like fodder means.

7. The calendar according to claim 1 wherein the objects are packed or are not packed.

8. The calendar according to claim 1 wherein the objects (9) exhibit an outer form of a regular or irregular outer shape for inciting the respective drive of a domestic animal to play, wherein the objects have a more or less limited moveability.

9. The calendar according to claim 9, wherein the objects (9) are furnished with an attachment agent for hanging up the objects.

10. The calendar according to claim 1 wherein the receiving means (4) for the objects (9) comprise in each case a chamber, wherein the chamber is openable and closable by employing a closure element.

11. The calendar according to claim 1 wherein a calendar front (1) is provided, wherein the calendar front (1) is disposed in front of a support element (2), and wherein the calendar front (1) is attached to the support element (2), wherein receiving means (4) are furnished in the support element (2) comprising individual chambers, and wherein the closure elements coordinated to the chambers are furnished as doors (5), wherein the doors (5) are flippable out of the calendar front (1) by employing of a member of the group consisting of folding lines (6), perforation elements, intended pre-weakened breakage positions (7), and combinations thereof.

12. The calendar according to claim 1 wherein the calendar front (1) is formed according to a member of the group consisting of a two-dimensional structure with a geometrically uniform shape, a two-dimensional structure with a contour shape, a three-dimensional structure and combinations thereof.

13. The calendar according to claim 1 wherein the calendar includes a calendar front (1), wherein the calendar front is colored and covered with a member of the group consisting of animal motives, plant motives, and combinations thereof.

14. The calendar according to claim 1 further comprising a support element (2), wherein the support element is made of a suitable working material for a reception of objects (9) made of a feeding agent.

15. The calendar according to claim 14 wherein the support element (2) is made out of a member of the group consisting of plastic, cardboard, wood, a suitable recycling material, a coated material, an uncoated material and combinations thereof.

16. The calendar according to claim 15 wherein the support element (2) is formed with a shape, wherein the shape is a member of the group selected from a geometric uniform shape, and a contour shape corresponding to the shape of the calendar front (1).

17. A calendar for domestic animals comprising
a calendar front;
a plurality of receiver means disposed behind the calendar front;
a plurality of pet consumption articles disposed in the plurality of receiver means;
a plurality of shutters disposed in the calendar front, disposed in front of the pet consumption articles and corresponding to the plurality of receiver means, wherein the shutters are closable for harboring the pet consumption articles and are openable for releasing the pet consumption articles.

18. The calendar according to claim 17 further comprising
a plurality of shaped envelope jackets surrounding the plurality of pet consumption articles, wherein the pet consumption articles comprise particle like fodder means, which have received a shape based on the shaped envelope jackets surrounding particle like fodder means.

19. The calendar according to claim 17 further comprising
a support for holding the receiver means, wherein the support is attached to the calendar front.

20. The calendar according to claim 17 wherein the shutters are furnished as doors, wherein the doors are flippable out of the calendar front by employing of a member of the group consisting of folding lines, perforation elements, intended pre-weakened breakage positions, and combinations thereof for performing a hinge function of said doors.
